(19) United States
(12) Patent Application Publication
(10) Pub. No.: US 2013/0110602 A1
(43) Pub. Date: May 2, 2013

(54) MOBILE TERMINAL AND METHOD OF PROVIDING SOCIAL COMMERCE SERVICE THEREIN USING SNS

(71) Applicant: Sungwon CHO, Seoul (KR)

(72) Inventor: Sungwon CHO, Seoul (KR)

(73) Assignee: LG ELECTRONICS INC., Seoul (KR)

(21) Appl. No.: 13/407,198

(22) Filed: Feb. 28, 2012

(30) Foreign Application Priority Data
Oct. 31, 2011 (KR) 10-2011-0112105

(51) Int. Cl. G06Q 30/06; G06Q 30/02

(52) U.S. Cl. 705/14.23; 705/26.1

(57) ABSTRACT

A mobile terminal and method of providing a social commerce service therein using SNS are discussed. The present invention relates to a method for a server, which manages SNS (social network service), to provide a social commerce service.

Pursuant to 35 U.S.C. §119(a), this application claims the benefit of earlier filing date and right of priority to Korean Application No. 10-2011-0112105, filed on Oct. 31, 2011, the contents of which are hereby incorporated by reference herein in their entirety.

### BACKGROUND OF THE INVENTION

1. Field of the Invention

The present invention relates to a mobile terminal, and more particularly, to a mobile terminal and method of providing a social commerce service therein using SNS. Although the present invention is suitable for a wide scope of applications, it is particularly suitable for providing a social commerce service using a social network service.

2. Discussion of the Related Art

Recently, the ongoing development of the communication technology enables a social commerce system as one of systems of connecting a service provider desiring to provide a service and a customer desiring to receive a service.

Social commerce means an electronic commercial transaction performed via a social network service (hereinafter abbreviated SNS). The social commerce is a sort of an electronic commercial transaction and corresponds to a sale system for providing a commodity at an exceptionally reduced price if a predetermined number of purchasers or more gather. And, the social commerce may be called social shopping. Such a name is used because purchasers desiring to purchase goods mainly use the social network service in the course of gathering joint purchasers.

The terminology ‘social commerce’ has been initially introduced through such a site as Shoposphere that is a pick-list sharing service of Yahoo in 2005. And, the terminology ‘social commerce’ starts to be known after the success of a business model of a joint purchase type social commerce initially launched by the online discount coupon company ‘Groupon’ established at Chicago, U.S.A. in 2008. In particular, as smart phones and social network services are being popularized, ongoing attention is paid to the social commerce as a new consumer market.

FIG. 1 is a diagram for a social commerce service.

Referring to FIG. 1, a service provider 10 makes a contract related to a coupon offer and advertisement in association with a social commerce service with a social commerce company 20. Generally, contract substance follows agreement between contracting parties. Yet, the contract substance between the service provider 10 and the social commerce company 20 in association with the social commerce service is set for the conditions for concluding the social commerce service. For instance, the conditions for the service conclusion may include a discount rate for a minimum number of invited members, the number of invited members such as a percentage, and the substance for the discount rate. Moreover, the conditions for the service conclusion may further include the substance for a social commerce service commission or fee and the like.

The social commerce company 20 advertises for the contents of the corresponding social commerce service in a specific site operated by the social commerce company 20 or via a network service and makes a public announcement for the substance of the service conclusion conditions.

Each customer lured to the advertisement run by the social commerce company 20 individually pays a predetermined price to the social commerce company 20 and then purchases a conditional coupon. In this case, the conditional coupon means the coupon for using a service normally if ‘the number of invited members’ included in the service conclusion conditions is met.

If ‘the number of invited members’ is met according to the service conclusion conditions, the customers 31 to 35 having purchased the conditional coupons are able to obtain normal coupons to use the service, respectively.

### SUMMARY OF THE INVENTION

Accordingly, the present invention is directed to a mobile terminal and method of providing a social commerce service therein using SNS that substantially obviate one or more problems due to limitations and disadvantages of the related art.

An object of the present invention is to provide a method for an SNS subscriber to initiatively select and trade in a social commerce service using a social network service in applying a social commerce system.

Another object of the present invention is to provide a mobile terminal, by which an interface for an SNS subscriber to initiatively select and trade in a social commerce service in applying a social commerce system using a social network service.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method of providing a social commerce service, which is provided by a server managing SNS (social network service), according to the present invention includes the steps of providing a sale information on a use authority of the social commerce service to a plurality of SNS subscriber terminals subscribed to the SNS, the sale information on the use authority including an information on a specific number of the SNS subscriber terminals intending to buy the use authority as a conclusion condition for selling the use authority of the social commerce service and an information on the social commerce service, receiving an information on SNS subscribers amounting to the specific number or higher, the SNS subscribers intending to buy the use authority, the SNS subscribers invited by a specific SNS subscriber terminal among a plurality of the SNS subscriber terminals, and if the SNS subscriber terminals amounting to the specific number or higher are confirmed to intend to buy the use authority of the social commerce service, selling the use authority of the social commerce service to each of the SNS subscriber terminals intending to buy the use authority.

Preferably, the use authority selling step includes the steps of providing payment-necessary information to each of the SNS subscriber terminals intending to buy the use authority, receiving payment authentication information from each of the SNS subscriber terminals to correspond to the payment-necessary information, and providing coupon information including the use authority of the social commerce service to each of the SNS subscriber terminals.

Preferably, the use authority selling step includes the steps of providing payment-necessary information required for collective payment for all of the SNS subscriber terminals intending to buy the use authority to the specific SNS subscriber terminal, receiving payment authentication information from the specific SNS subscriber terminal to correspond to the payment-necessary information.

More preferably, the use authority selling step includes one of the steps of providing coupon information including the use authority of the social commerce service to each of the SNS subscriber terminals intending to buy the use authority and providing the coupon information including the use authority of the social commerce service to the specific SNS subscriber terminal.

Preferably, in the step of receiving the information on the SNS subscribers intending to buy the use authority, the specific SNS subscriber terminal determines a specific social commerce service to buy the authority thereof, selects SNS friends from a plurality of the SNS subscribers linked to the specific SNS subscriber on an SNS network, sends a message for inviting to join in buying the specific social commerce service to terminals of the selected specific SNS friends, receives a buy-intended message from each of the terminals of the SNS subscribers intending to buy the use authority in response to the message, and determines whether the specific number is met as the conclusion condition for the social commerce service from the buy-intended message of each of the SNS subscribers.

Preferably, the sale information further includes at least one selected from the group consisting of an expiry period for using the social commerce service, a volume information of the use authority of the social commerce service, a user response information on the social commerce service, and a user information on a user having selected the social commerce service.

In another aspect of the present invention, a mobile terminal, which is provided with a social commerce service using SNS (social network service), includes a wireless communication unit receiving a sale information on a use authority of each of at least one social commerce service from a server configured to manage the SNS, the sale information on the use authority including an information on a specific number of SNS subscriber terminals intending to buy the use authority as a conclusion condition for selling the use authority of the social commerce service and an information on the social commerce service, a user input unit receiving an input of a selection action on a specific one of the at least one social commerce service and an input of a selection action on specific SNS subscribers to invite to buy the specific social commerce service, and a controller controlling the wireless communication unit and the user input unit, the controller sending an invitation message for joining in buying the specific social commerce service to terminals of the selected specific SNS subscribers, the controller receiving a buy-intended message from SNS subscribers intending to buy the use authority in response to the invitation message, the controller determines whether the specific number is met as the conclusion condition of the specific social commerce service, the controller controlling information on SNS subscribers intending to buy the use authority to be transmitted to the SNS managing server.

Preferably, the mobile terminal further includes a display unit configured to provide an advertisement interface advertising for each of the at least one social commerce service using the sale information on the at least one social commerce service.

More preferably, the display unit displays the number of terminals of SNS subscribers intending to buy the use authority.

Preferably, the sale information includes at least one selected from the group consisting of an expiry period for using the social commerce service, a volume information of the use authority of the social commerce service, a user response information on the social commerce service, and a user information on a user having selected the social commerce service.

Preferably, if the conclusion condition for selling the use authority of the specific social commerce service is met as the SNS subscriber terminals over the specific number intend to buy the use authority, the wireless communication unit receives a coupon information including the use authority of the specific social commerce service from the SNS managing server.

More preferably, the mobile terminal further includes a memory configured to store the coupon information.

Technical tasks obtainable from the present invention may be non-limited by the above-mentioned technical tasks. And, other unmentioned technical tasks can be clearly understood from the following description by those having ordinary skill in the technical field to which the present invention pertains.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram for a social commerce service;

FIG. 2 is a schematic diagram of a configuration of SNS (social network service) social commerce service system according to the present invention;

FIG. 3 is a schematic flowchart of an SNS (social network service) social commerce service system according to the present invention;

FIG. 4 is a block diagram of a mobile terminal according to one embodiment of the present invention;

FIG. 5 is a diagram for providing an SNS social commerce service advertisement according to the present invention;

FIG. 6 is a diagram of proposing a customer invitation for an SNS social commerce service via a host terminal according to the present invention;

FIG. 7 is a diagram for an action of member invitation by a host terminal to persuade members to join SNS social commerce service;

FIG. 8 is a diagram of an operation for a target terminal 200 having received the message to display a content of a social commerce service;

FIG. 9 is a diagram for a pay action for an SNS social commerce service according to the present invention;

FIG. 10 is a diagram for an operation of managing a SNS social commerce service coupon according to the present invention;

FIG. 12 is a diagram for an action to share a coupon of an SNS social commerce service according to the present invention; and

FIG. 13A and FIG. 13B are diagrams for an action of transferring a coupon of an SNS social commerce service entirely or in part according to the present invention.

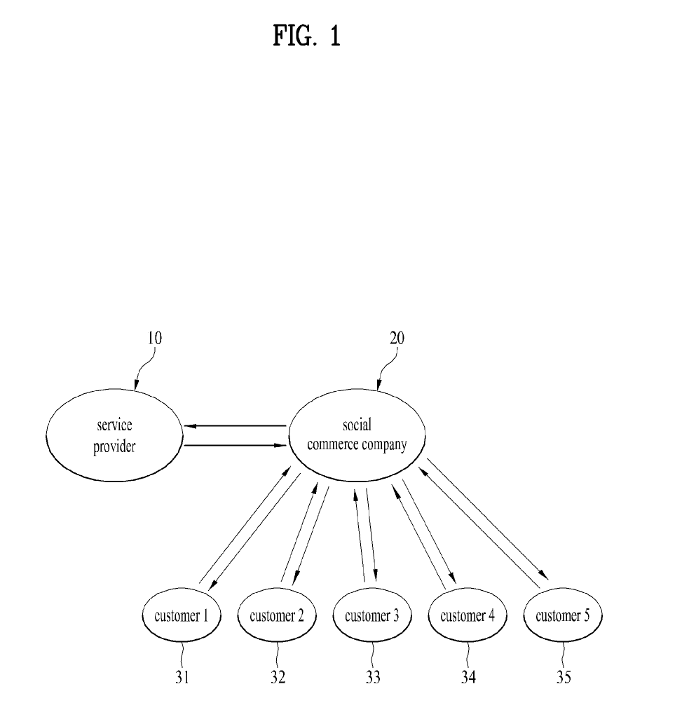

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts. The suffixes ‘module’ and ‘unit’ for the elements used in the following description are given or used in common by considering facilitation in writing this disclosure only but fail to have meanings or roles discriminated from each other.

First of all, mobile terminals described in this disclosure can include a mobile phone, a smart phone, a laptop computer, a digital broadcast terminal, a PDA (personal digital assistants), a PMP (portable multimedia player), a navigation system and the like

Moreover, a terminology ‘host terminal’ used in this specification may mean a terminal of an SNS subscriber who proposes an SNS social commerce service. And, a terminology ‘target terminal’ used in this specification may mean a terminal of an SNS subscriber who is invited to join an SNS social commerce service by a host terminal.

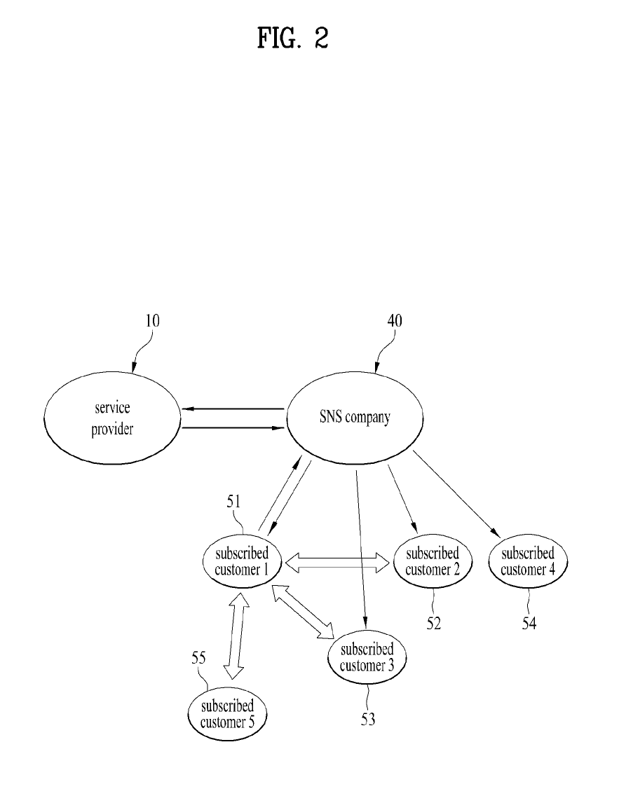

FIG. 2 is a schematic diagram of a configuration of SNS (social network service) social commerce service system according to the present invention.

Referring to FIG. 2, basic components of an SNS social commerce service system according to the present invention may include a service provider 10, an SNS (social network service) company 40, and subscriber customers 51 to 55 of SNS (social network service).

First of all, the service provider 10 means a company that provides services. For instance, the service provider 10 provides such a coupon for a service or article as a hamburger coupon, an amusement park coupon, an electronic appliance exchange coupon and the like.

The SNS company 40 means a subject that provides a social network service. In this case, the social network service means a service for engaging online relations with a plurality of unspecific parties. Customers subscribed to the social network service may be able to perform various kinds of online communications with other subscriber customers.

The SNS subscribers 51 to 55 mean customers having subscribed to the social network service operated by the SNS company 40. In the drawing, 5 subscribers are shown for clarity and convenience of the description. And, the number of subscribers may be non-limited.

The service provider 10 provides contract conditions related to the SNS (social network service) social commerce service to the SNS company 40. In this case, the service related contract conditions may include various substances such as a service advertisement, a condition for conclusion of the SNS (social network service) social commerce service, a service fee, a discount rate and the like.

The SNS company 40 provides various advertisements for the service to the subscribers subscribed to the SNS via a communication network in accordance with the contract conditions concluded with the service provider 10. These advertisement contents may be provided as a user interface to each terminal. The advertisement for the service may be provided temporarily or persistently.

In accordance with the advertisement provided by the SNS company 40, the subscribers 51 to 55 subscribed to the social network service may be able to check the advertisement contents. Each of the subscribers 51 to 55 is able to check the advertisement contents. And, one of the subscribers 51 to 55 may be able to propose an action of inviting members for a specific social network service in accordance with the advertisement contents. In the drawing, the subscriber customer 1 51 initiates the member inviting action for the specific social commerce service. In particular, one of the customers subscribed to the social network service selects a specific social commerce service and then performs an action for inviting members to meet the conclusion conditions of the specific social commerce service.

In the drawing, the subscriber customer 1 51 having selected a social commerce service sends a message for an invitation to join the specific social commerce service to his SNS friends, e.g., the subscriber customer 2 52, the subscriber customer 3 53 and the subscriber customer 5 55. If the number of the customers consented to join the social commerce service among the corresponding SNS friends meets the conclusion conditions for the social commerce service sale, a coupon for the corresponding social commerce service is provided.

According to the present invention, unlike the related art, in order to meet the conclusion conditions for the sale of a social commerce service, a subscriber customer belonging to SNS plays an initiative role in inviting corresponding members.

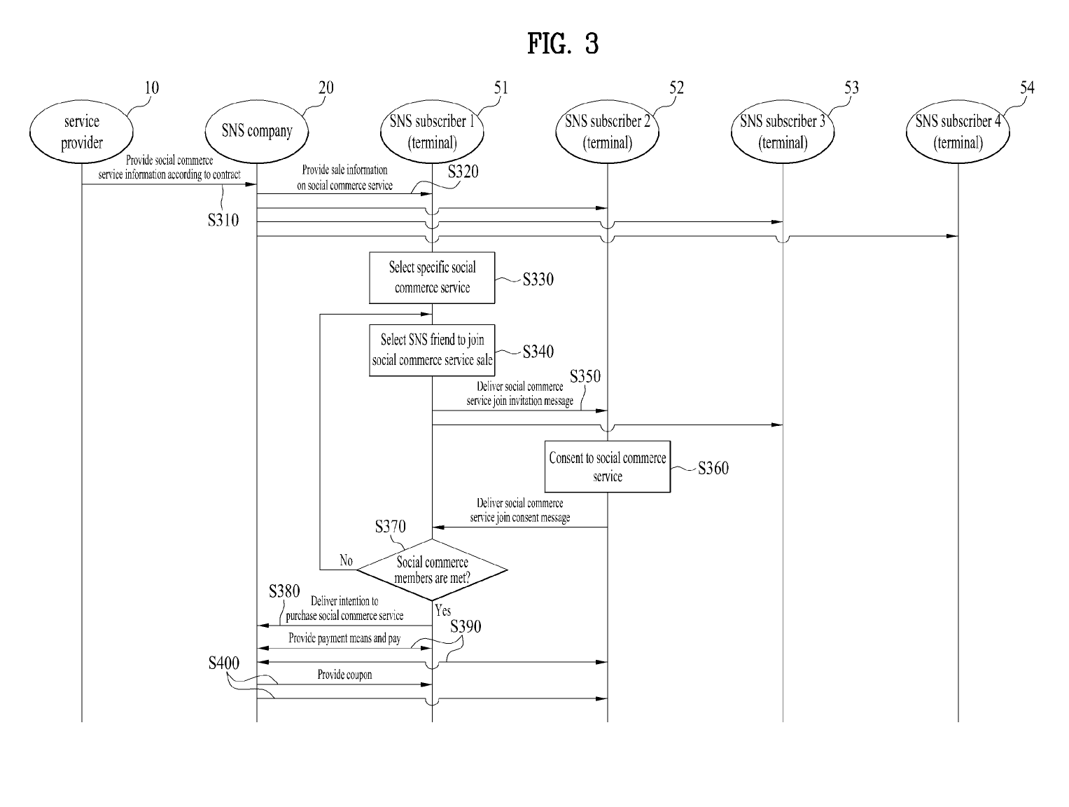

FIG. 3 is a schematic flowchart of an SNS (social network service) social commerce service system according to the present invention.

Referring to FIG. 3, a service provider 10 for providing a service provides an SNS company 20 with a social commerce service information according to the contracts [S310].

The SNS company 20 provides sale information on a social commerce service to terminals 51 to 54 of customers subscribed to SNS (social network service) managed by the SNS company 20 [S320].

The terminal 51 of SNS subscriber 1, who is the customer of one of the SNS subscriber terminals 51 to 54 selects a specific social commerce service from a plurality of social commerce services [S330].

The terminal 51 of the SNS subscriber 1, i.e., a host terminal 51 selects SNS friends who will join the social commerce service sale [S340].

The terminal 51 of the SNS subscriber 1 delivers a message for inviting to join the social commerce service to the terminals 52 and 53 of the SNS subscribers 2 and 3 who are the selected SNS friends [S350].

One of the SNS friends having received the message for inviting to join the social commerce service, i.e., the terminal 52 of the SNS subscriber 2 consents to join the social commerce service and then delivers a consent message [S360].

The terminal 51 of the SNS subscriber 1 determines whether the conclusion conditions for the sale of the terminal 51 of the SNS subscriber 1 are met [S370]. If the conclusion conditions are not met, the terminal 51 of the SNS subscriber 1 goes back to the step S340 and then selects SNS friends to join the terminal 51 of the SNS subscriber 1 again.

If the members are stratified, the terminal 51 of the SNS subscriber 1 delivers an intention to purchase the terminal 51 of the SNS subscriber 1 to the SNS company 20 [S380].

The SNS company 20 provides a payment means for the social commerce service to the terminal 51 of the SNS subscriber 1 and the terminal 52 of the SNS subscriber 2, who have consented to the terminal 51 of the SNS subscriber 1 [S390].

If the payment is settled, the SNS company 20 provides a coupon for the corresponding social commerce service to the terminal 51 of the SNS subscriber 1 and the terminal 52 of the SNS subscriber 2 [S400].

According to the present invention, the terminals to 54 of the SNS subscribers correspond to SNS users, respectively. If the present invention applies, each of the terminals may mean the mobile terminal 100. In particular, the SNS subscriber or customer of the present invention performs various actions including an advertisement for a social commerce service, a social commerce member selecting action, a payment action, a coupon offer and the like using the mobile terminal 100.

Moreover, the service provider 10 and the SNS company 20 may be able to perform the operation of the present invention using a service providing server and an SNS server as well.

In the following description, a configuration of the mobile terminal 100 according to the present invention is explained.

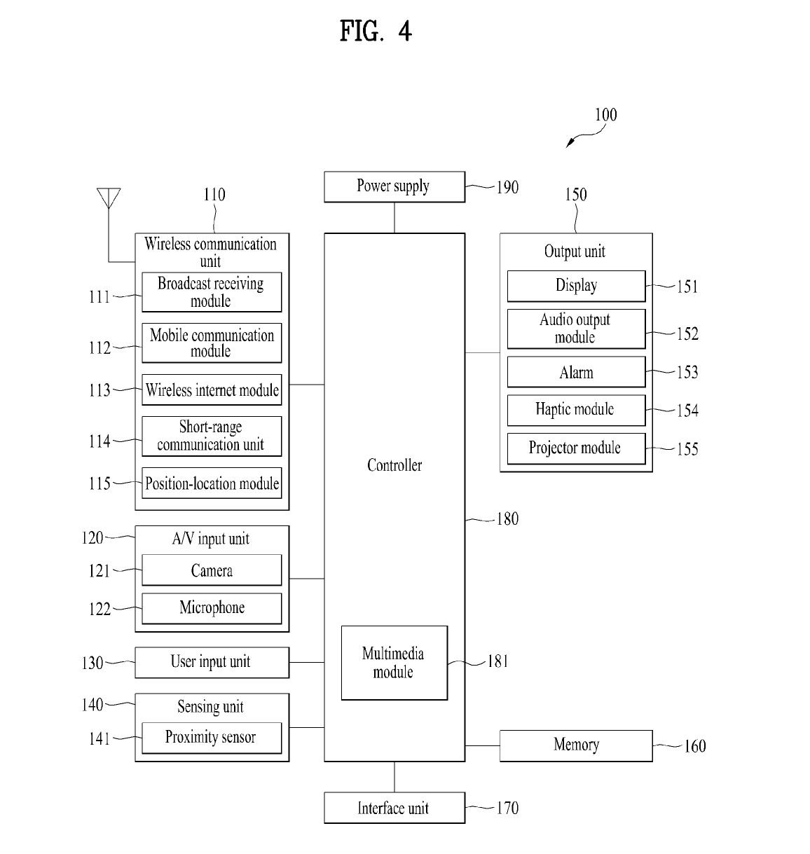

FIG. 4 is a block diagram of a mobile terminal according to one embodiment of the present invention.

Referring to FIG. 4, the mobile terminal 100 may include a wireless communication unit 110, an A/V (audio/video) input unit 120, a user input unit 130, a sensing unit 140, an output unit 150, a memory 160, an interface unit 170, a controller 180, a power supply unit 190 and the like. FIG. 4 may show the mobile terminal 100 having various components, but it is understood that implementing all of the illustrated components is not a requirement. Greater or fewer components may be alternatively implemented.

In the following description, the above components of the mobile terminal 100 are explained in sequence.

First of all, the wireless communication unit 110 may typically include at least one component or module which permits wireless communication between the mobile terminal 100 and a wireless communication system or network within which the mobile terminal 100 is located. For instance, the wireless communication unit 110 may include a broadcast receiving module 111, a mobile communication module 112, a wireless internet module 113, a short-range communication module 114, a position-location module 115 and the like.

Referring to FIG. 4, the audio/video (A/V) input unit 120 is configured to provide an audio or video signal input to the mobile terminal 100. As shown, the A/V input unit 120 may include a camera 121, a microphone 122 and the like. The camera 121 receives and processes image frames of still pictures or video, which are obtained by an image sensor in a video call mode or a photographing mode. And, the processed image frames may be displayed on the display unit 151.

The image frames processed by the camera 121 may be saved in the memory 160 or may be externally transmitted via the wireless communication unit 110. Optionally, at least two cameras 121 may be provided to the mobile terminal 100 according to environment of usage.

The output unit 150 is configured to generate outputs relevant to the senses of sight, hearing, touch and the like. And, the output unit 150 may include the display unit 151, an audio output module 152, an alarm unit 153, a haptic module 154, a projector module 155 and the like.

The display unit 151 may be implemented using known display technologies including, for example, a liquid crystal display (LCD), a thin film transistor-liquid crystal display (TFT-LCD), an organic light-emitting diode display (OLED), a flexible display and a three-dimensional display. The mobile terminal 100 may include one or more of such displays.

Some of the above displays can be implemented in a transparent or optical transmittive type, which can be named a transparent display. As a representative example for the transparent display, there is TOLED (transparent OLED) or the like. A rear configuration of the display unit 151 may be implemented in the optical transmittive type as well. In this configuration, a user is able to see an object in rear of a terminal body via the area occupied by the display unit 151 of the terminal body.

A proximity sensor 141 may be provided to an internal area of the mobile terminal 100 enclosed by the touchscreen or around the touchscreen. The proximity sensor 141 is the sensor that detects a presence or non-presence of an object approaching a prescribed detecting surface or an object existing around the proximity sensor using an electromagnetic field strength or infrared ray without mechanical contact. Hence, the proximity sensor 141 has durability longer than that of a contact type sensor and also has utility wider than that of the contact type sensor.

The memory unit 160 is generally used to store various types of data to support the processing, control, and storage requirements of the mobile terminal 100. Examples of such data include program instructions for applications operating on the mobile terminal 100, contact data, phonebook data, messages, audio, still pictures, moving pictures, etc. And, a recent use history or a cumulative use frequency of each data (e.g., use frequency for each phonebook, each message or each multimedia) may be saved together in the memory unit 160. Moreover, data for various patterns of vibration and/or sound outputted in case of a touch input to the touchscreen may be saved in the memory unit 160.

The interface unit 170 is often implemented to couple the mobile terminal 100 with external devices. The interface unit 170 receives data from the external devices or is supplied with the power and then transfers the data or power to the respective components of the mobile terminal 100 or enables data within the mobile terminal 100 to be transferred to the external devices. For example, the interface unit 170 may be configured using a wired/wireless headset port, an external charger port, a wired/wireless data port, a memory card port, a port for coupling to a device having an identity module, audio input/output ports, video input/output ports, an earphone port and/or the like.

The controller 180 typically controls the overall operations of the mobile terminal 100. For example, the controller 180 performs the control and processing associated with voice calls, data communications, video calls, etc. The controller 180 may include a multimedia module 181 that provides multimedia playback. The multimedia module 181 may be configured as a part of the controller 180, or implemented as a separate component.

Moreover, the controller 180 is able to perform a pattern recognizing process for recognizing a writing input and a picture drawing input performed on the touchscreen as characters or images, respectively.

The power supply unit 190 provides power required by the various components for the mobile terminal 100. The power may be internal power, external power, or combinations thereof.

Various embodiments described herein may be implemented in a computer-readable medium using, for example, computer software, hardware, or some combination thereof.

For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller 180.

For a software implementation, the embodiments described herein may be implemented with separate software modules, such as procedures and functions, each of which perform one or more of the functions and operations described herein. The software codes can be implemented with a software application written in any suitable programming language and may be saved in memory such as the memory 160, and executed by a controller or processor, such as the controller 180.

In the following description, a flow of the SNS social commerce service system according to the present invention shown in FIG. 3 is explained.

First of all, the service provider 10 provides social commerce service information according to the contracts with the SNS company 20 [S310].

The service provider 10 and the SNS company 20 may set the contract conditions for the SNS social commerce service to various conditions. For instance, a discount rate may be set different in accordance with the number of joinings. For another instance, a purchase condition for the social commerce service may be set to one of various ways including an individual purchase, a joint purchase and the like. The service provider 10 and the SNS company 20 may be able to set advertisement conditions for the social commerce service. And, he service provider 10 and the SNS company 20 may be able to set a contract for a social commerce coupon if a conclusion condition for the social commerce service is met. Accordingly, the service provider 10 may provide various kinds of informations to the SNS company 20 according to these contracts.

Alternatively, instead of making a contract with one service provider, the SNS company 20 may set contracts for various social commerce services from at least one service provider and may be provided with service informations on the various services.

Subsequently, the SNS company 20 provides sale information on a social commerce service to the customers 51 to 54 subscribed to SNS (social network service) managed by the SNS company 20 [S320].

In this case, the sale information may include on the social commerce service and may also include a conclusion condition to conclude the social commerce service sale. In particular, assuming that the social commerce service sale is concluded only if the number of members meets a predetermined number, this member condition may be regarded as the conclusion condition. And, the information on the social commerce service may include advertisement information indicating what kind of service the social commerce service is.

The SNS company 20 may be able to perform an advertisement action for the social commerce service. The SNS company 20 is the host or subject that operates a specific social commerce service. And, a target for the advertisement may include subscribers subscribed to the specific social commerce service, i.e., subscriber terminals.

The SNS company 20 provides an advertisement for the social commerce service to the targets of the subscribed customers and may provide a social commerce service advertisement to each off the terminals of the subscribed customers.

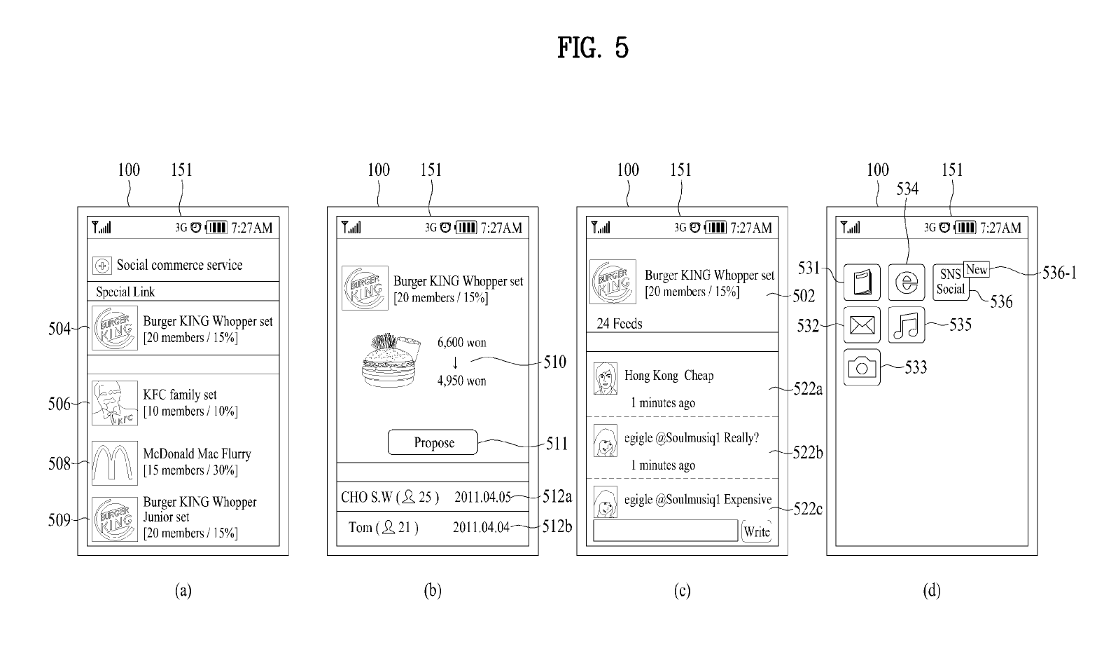

FIG. 5 is a diagram for providing an SNS social commerce service advertisement according to the present invention.

Referring to FIG. 5, the SNS company 20 delivers advertisement information on a social commerce service to SNS subscriber terminals and each of the SNS subscriber terminals may be able to display an advertisement for the social commerce service.

Referring to FIG. 5 (a), advertisements for a plurality of social commerce services are provided via a display unit 151 of a specific SNS terminal 100.

In doing so, the terminal provided with the advertisements may include every terminal belonging to the corresponding social commerce service.

The display unit 151 of the SNS terminal 100 may display advertisements 504, 506, 508 and 509 for a plurality of the social commerce services in accordance with a specific category 502. In doing so, each of the advertisements may provide schematic information on a title of the social commerce service, a conclusion condition for the social commerce service and the like.

Referring to FIG. 5 (b), the advertisement on a specific social commerce service is provided via the display unit 151 of the specific SNS terminal 100.

If the advertisement for the specific social commerce service is selected from the advertisements for a plurality of the social commerce services in FIG. 5 (a), detail information on the corresponding specific social commerce service is provided. For instance, in the drawing, various kinds of informations on a fee for a corresponding social commerce service, a discount rate and the like may be provided. Moreover, through a ‘propose’ menu 511, it may be able to initiate a member inviting action for the corresponding social commerce service.

In FIG. 5 (b), it may be able to provide information on other SNS subscribers having selected or proposed the corresponding social commerce service via a specific window provided to the bottom of the display unit 151. For instance, it may be able to indicate that SNS subscriber ‘CHO Sung Won’ has invited 25 members using a 1^{st} window 512a. And, it may be able to indicate that SNS subscriber ‘Tom’ has invited 21 members using a 2^{nd} window 512b.

Referring to FIG. 5 (c), estimations of the specific social commerce service by other subscribers or customers may be displayed by real time. In particular, comments on the specific social commerce service by other customers subscribed to the SNS via a communication network may be provided together with the corresponding advertisement content.

Referring to FIG. 5 (d), a plurality of icons 531 to 536 are displayed on the display unit 151 of the specific SNS terminal 100. In doing so, the advertisement icon 536 for the social commerce service may be included in the display unit 151. In particular, although the social commerce service may be displayed in direct, as shown in FIG. 5 (a) to FIG. 5 (c), it may be displayed indirectly via the social commerce service icon 536. In case that a new social commerce service advertisement is present, a presence of the new social commerce service advertisement may be indicated via a mark ‘new’ 536-1. Optionally, if the advertisement icon 536 is selected, it may be set to be linked to the social commerce service advertisement.

Subsequently, a specific SNS subscriber terminal among the SNS subscribers selects a specific social commerce service from a plurality of the social commerce services [S330].

According to the present invention, all of a plurality of the SNS subscribers provided with the social commerce service advertisement may not need to propose the customer inviting action of the corresponding social commerce service. If an SNS subscriber among a plurality of subscribers selects to propose a customer inviting action of a social commerce service, the present invention may apply.

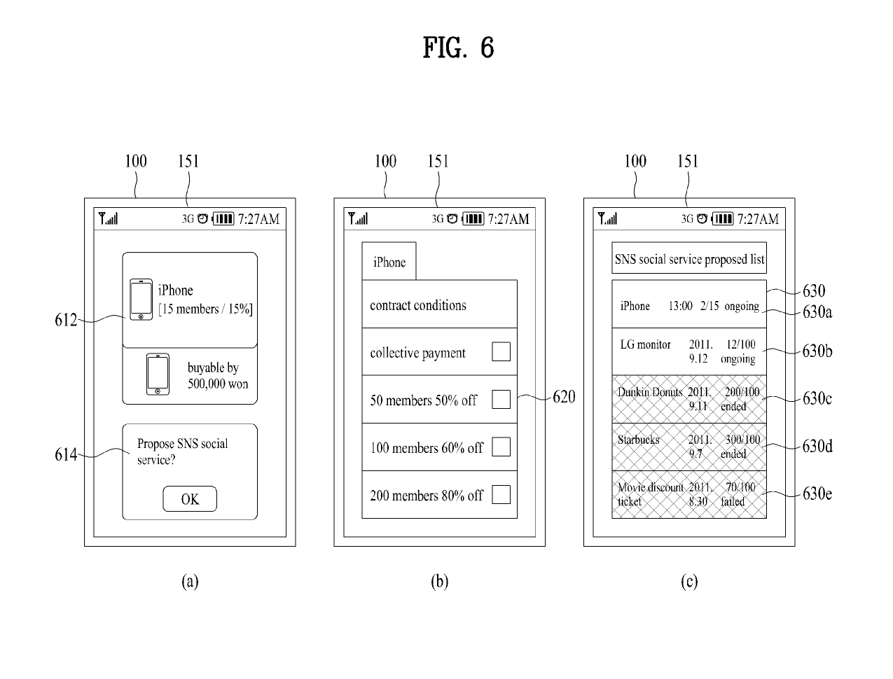

FIG. 6 is a diagram of proposing a customer invitation for an SNS social commerce service via a host terminal according to the present invention.

In this specification, ‘proposing’ a customer invitation may mean an action of initiating invitation of customers to meet the conclusion conditions of SNS social commerce service. Hence, if a terminal of a specific SNS subscriber performs a proposing action, it may initiate an action of luring other SNS subscribers into customers of SNS social commerce service.

Referring to FIG. 6 (a), a specific social commerce service advertisement window 612 and a window 614 indicating whether to propose a customer invitation for SNS social commerce service are displayed on a display unit 151 of a specific SNS subscriber. If the specific SNS subscriber selects to propose the customer invitation for the SNS social commerce service, a terminal 100 of the specific SNS subscriber sends a message for joining the SNS social commerce service to terminals of other SNS subscribers via SNS network.

In this case, for clarity, a subjective terminal for proposing the customer invitation for the SNS social commerce service may be named a host terminal 100 and a terminal corresponding to a joining target of the customer invitation for the SNS social commerce service may be named a target terminal 200.

Referring to FIG. 6 (b), if the customer invitation is proposed for the SNS social commerce service via the host terminal 100, a content of the corresponding SNS social commerce service is displayed on the display unit 151. In this case, the content of the SNS social commerce service may include various kinds of informations. For instance, a content related to a payment condition may be included or discount rate information according to the number of joinings may be provided. Optionally, contract conditions may be selected in various ways according to a user selection.

Referring to FIG. 6 (c), the host terminal 100 provides a list of SNS social commerce services previously proposed. In particular, the terminal may propose customer invitations of various SNS social commerce services or may provide previously proposed SNS social commerce services. The list of the proposed SNS social commerce services may include services 630a and 630b having the customer invitation in progress and services 630c to 630e having customer invitation ended.

Subsequently, the host terminal 100 of the subscriber having proposed the SNS social commerce service selects a social commerce member 340 to meet the customer number that is the conclusion condition of the social commerce service [S340].

The present invention may be characterized in meeting a conclusion condition of a social commerce service in a manner that one member subscribed to a social commerce service persuades other subscribers via his terminal. Therefore, using the host terminal 100, other SNS subscribers are informed of a presence of a corresponding SNS social commerce service and an action of persuading the SNS subscribers to join the corresponding SNS social commerce service is performed.

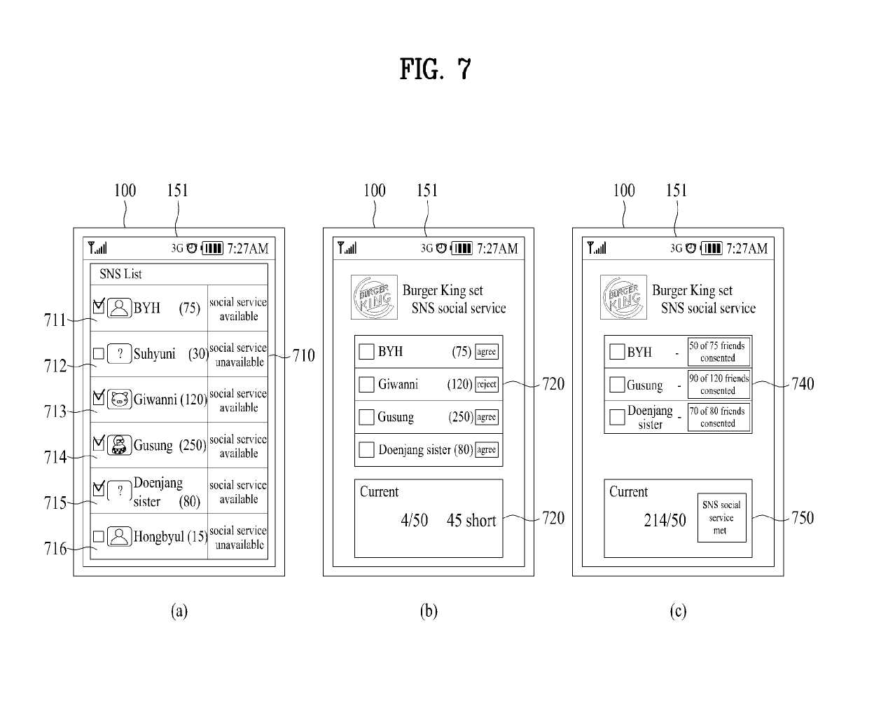

FIG. 7 is a diagram for an action of member invitation by a host terminal to persuade members to join SNS social commerce service.

Referring to FIG. 7 (a), a list of SNS friends of a social network of a subscriber, who is a user of a host terminal 100, is displayed on a display unit 151 of the host terminal 100. Owing to the property of a social network service, subscribers subscribed to the social network service may include a list of a plurality of acquaintances or friends.

In FIG. 7 (a), various SNS subscribers 711 to 716 are shown as SNS friends of the user of the host terminal 100. In particular, various kinds of informations of the SNS subscribers 711 to 716 may be included in the list. For instance, a name, nickname, phone number, photo and email address of each of the SNS subscribers may be included. The present invention may include additional information in association with a social network service. For instance, the information on the 1^{st} subscriber 711 may include initials ‘BYH’ of the subscriber, an image of the subscriber and the number (e.g., 75) of SNS acquaintances of the 1^{st} subscriber 711 and may further include an indication of a presence or non-presence of possibility in joining SNS social commerce service.

In FIG. 7 (a), although the host terminal 100 displays a plurality of the SNS subscribers 711 to 716 as a plurality of SNS acquaintances, it may be unnecessary for the host terminal 100 to persuade all of the acquaintances to join the SNS social commerce service. Hence, the host terminal 100 selects the SNS subscribers 711, 713, 714 and 715 from a plurality of the SNS subscribers 711 to 716 and may persuade the selected SNS subscribers to join the SNS social commerce service.

Referring to FIG. 7 (b), the host terminal 100 may display the SNS subscribers persuaded to join the SNS social commerce service only. In doing so, information indicating whether each of the persuaded subscribers consents to the SNS social commerce service may be included. Moreover, a current status indicating whether the number of SNS social commerce service members is insufficient may be displayed on a status window 730.

According to the present invention, SNS friends of the subscriber of the host terminal 100 and other SNS friends of each of the SNS friends of the subscriber of the host terminal 100 may join the SNS social commerce service as members thereof. For instance, if the subscriber of the host terminal 100 have 3 SNS friends A, B and C, the SNS friend A has 2 SNS friends a1 and a2, the SNS friend B has 2 SNS friends b1 and b2, and the SNS friend C has 3 SNS friends c1, c2 and c3, all the SNS friends a1, a2, b1, b2, c1, c2 and c3 may become the members of the SNS social commerce service as well as the SNS friends A, B and C of the subscriber of the host terminal 100. In this case, each terminal of the SNS friends A, B and C may be able to deliver an advertisement and joining message of the SNS social commerce service.

Referring to FIG. 7 (c), it may be able to check SNS social commerce service joining actions through the SNS friends of the subscriber of the host terminal 100. As mentioned in the foregoing description, the SNS friends of the subscriber's SNS friends may be able to join the SNS social commerce service as well as the subscriber's SNS friend and the host terminal 100 may be able to check the joining actions of the SNS friends of the subscriber's SNS friends. For instance, the SNS friends ‘BYH’, ‘Gusung’ and ‘Doenjang sister’ of the subscriber of the host terminal 100 are displayed on a 1^{st} check window 740. And, through the 1^{st} check window 740, it may be able to confirm that 50 of 75 SNS friends of the SNS friend ‘BYH’ have consented, that 90 of 120 SNS friends of the SNS friend ‘Gusung’ have consented, and that 70 of 80 SNS friends of the SNS friend ‘Doenjang sister’ have consented.

Hence, through a 2^{nd} check window 750 of the host terminal 100, it may be able to confirm that the number of members joining the SNS social commerce service is 214 and that the requirements for the SNS social commerce service is met, through a 2^{nd} check window 750.

Optionally, the host terminal 100 may be able to select other counterparts not belonging to the SNS friends as well as the SNS friends if necessary. For instance, the host terminal 100 may be able to select other members saved in a phonebook as targets to join the SNS social commerce service.

Subsequently, the host terminal 100 delivers a message for persuading the selected SNS friends to join the social commerce service to the selected SNS friends [S350].

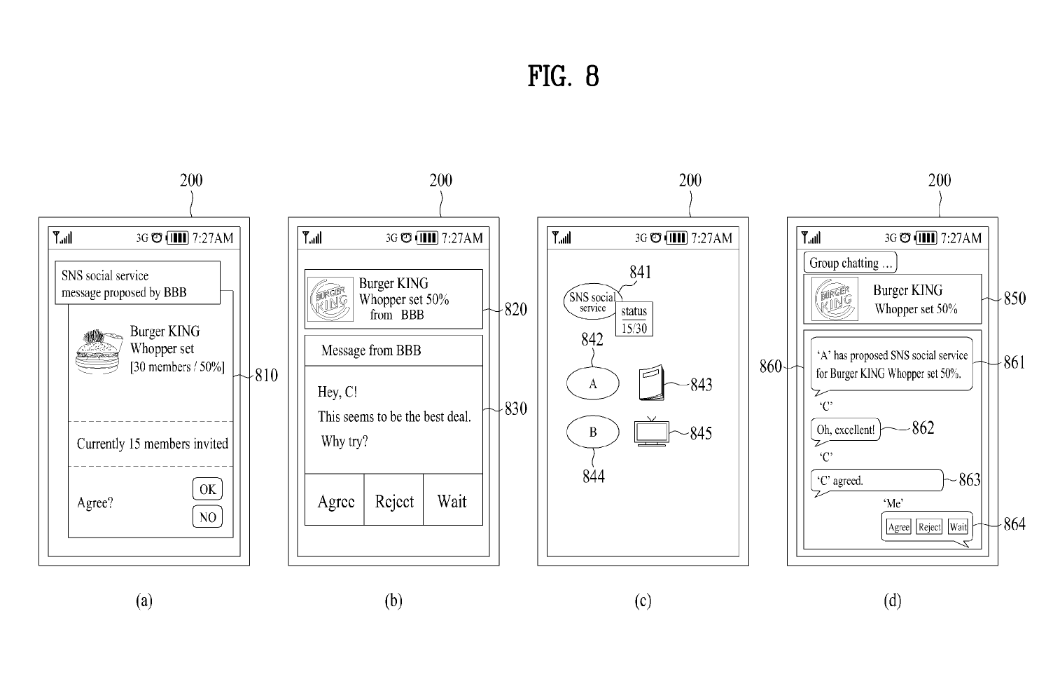

FIG. 8 is a diagram of an operation for a target terminal 200 having received the message to display a content of a social commerce service.

Referring to FIG. 8, the host terminal 100 sends a message for persuading the selected SNS friends to join the social commerce service to the selected SNS friends. And, a target terminal 200 corresponding to a terminal of each of the SNS friends receives and displays the corresponding message. In this case, a format of the message for persuading the selected SNS friends to join the social commerce service may be non-limited by a specific type.

Referring to FIG. 8 (a), the target terminal 200 receives an SNS social commerce service joining invitation message and then displays information on the SNS social commerce service. Hence, a content of the SNS social commerce service and the number of currently joining members thereof.

Referring to FIG. 8 (b), the SNS social commerce service joining invitation message may include a written message of the host terminal 100. Hence, the target terminal 200 may be able to display the written message 830 of the host terminal 100 as well as information 820 on the SNS social commerce service.

Referring to FIG. 8 (c), in case of receiving the SNS social commerce service joining invitation message, the target terminal 200 may be able to display an icon linked to the SNS social commerce service from the message. The target terminal 200 may be able to various icons 841 to 845 through a display unit. In particular, a specific one 841 of the various icons 841 to 845 may be displayed as the icon linked to the information on the SNS social commerce service. In more particular, the specific icon 841 may represent information on a presence of the SNS social commerce service to be joined by invitation and the number of current joining members in case of joining the SNS social commerce service by real time.

Referring to FIG. 8 (c), the SNS social commerce service joining invitation message may be provided to the target terminal 200 in a manner of a chat. In particular, chat operations of various SNS subscribers may be displayed on a chat window 860. In this case, the target terminal 200 may be able to check an information 861 on the SNS social commerce service joining invitation message.

As mentioned in the foregoing description, each of the SNS subscribers having received the SNS social commerce service joining invitation message gives his consent and then sends a consent message [S360]. The host terminal 100 having proposed the customer invitation to the SNS social commerce service determines whether the number of members for the conclusion of the social commerce service is met. If the number of members is met, the host terminal 100 delivers a social commerce service purchase intention to the SNS company 20 [S370, S380].

As mentioned in the foregoing description, if a plurality of SNS friends join the SNS social commerce service to meet the requirement regarding whether the number of members of the SNS social commerce service proposed by the host terminal 100 is met, the host terminal 100 may be able to deliver a result of meeting the corresponding service condition and a service purchase intention to the SNS company 20.

Subsequently, the SNS company 20 provides a payment means for the social commerce service to the SNS subscribers having contented to the social commerce service [S390].

According to the present invention, the SNS company 20 may be able to provide all means for the payment as well as the advertisement for the presence and information of the social commerce service. The SNS company 20 may facilitate a payment action using a network with a financial company as well a user interface.

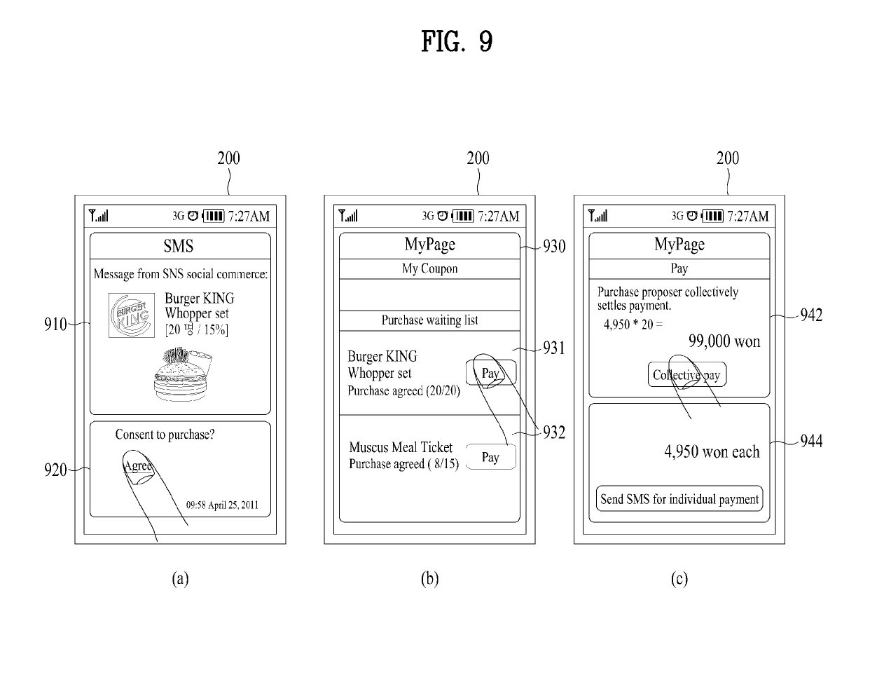

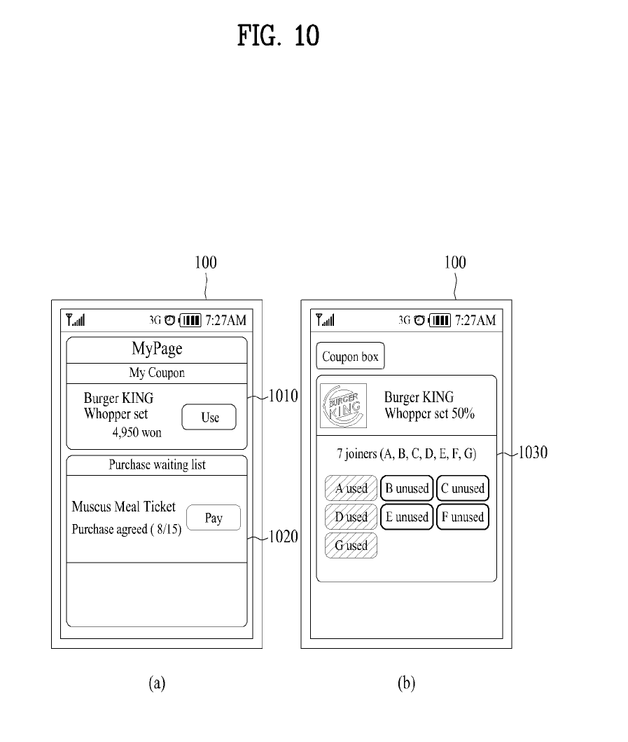

FIG. 9 is a diagram for a pay action for an SNS social commerce service according to the present invention.

Referring to FIG. 9, the terminal 200 or 100 of each of the SNS subscribers having consented to the SNS may be provided with a payment means by the SNS company 20. In this case, the provided payment means may be represented in various ways. For instance, the payment means may be provided via a user interface.

FIG. 9 (a) shows an action for a target terminal 200 to select to pay for a specific SNS social commerce service. Referring to FIG. 9 (a), a target terminal 200 or a host terminal 200 consenting to an SNS social commerce service may include a plurality of social commerce service targets on standby for a purchase. In the drawing, the terminal 200 includes a 1^{st} SNS social commerce service 911 and a 2^{nd} SNS social commerce service 912 and may display each of the 1^{st} and 2^{nd} SNS social commerce services 911 and 912. If one of the 1^{st} and 2^{nd} SNS social commerce services 911 and 912 is selected, the terminal 20 performs a payment operation. And, information related to this payment operation is delivered to the SNS company 20.

FIG. 9 (b) shows various payment methods in case that a specific SNS social commerce service is paid for. The SNS social commerce service may include a method 921 for a purchase proposer to collectively settle the payment and a method 922 for each SNS subscriber to purchase the SNS social commerce service individually.

Finally, if the terminals settle the payments, the SNS company 20 provides a corresponding social commerce service coupon to each of the terminals having consented to or settled the payment for the SNS social commerce service [S400].

The SNS company 20 delivers the social commerce service coupon delivered from the service provider 10 to the corresponding terminal. And, a user may be able to receive a service provided by the service provider using the coupon delivered to the corresponding terminal.

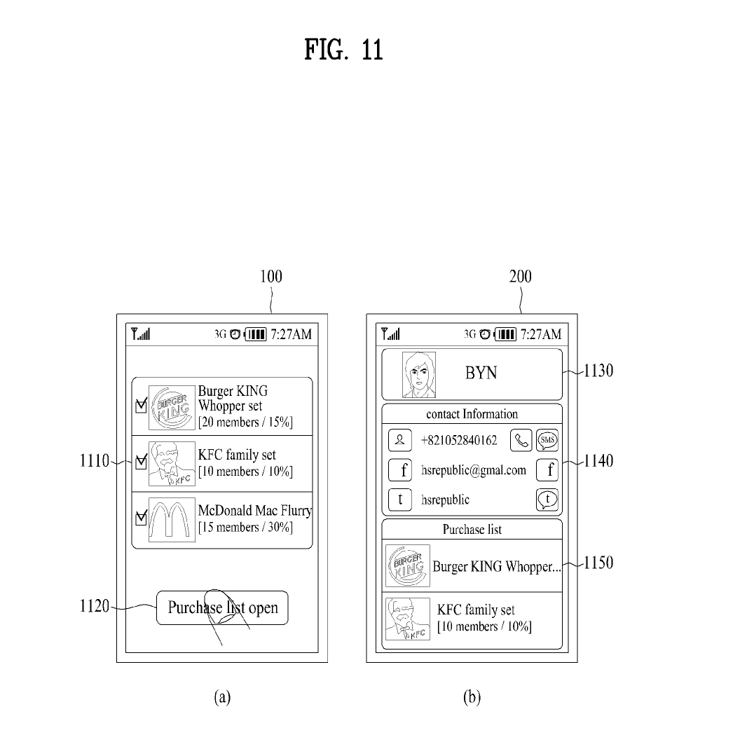

FIG. 10 is a diagram for an operation of managing a SNS social commerce service coupon according to the present invention.

Referring to FIG. 10 (a), a terminal 100 displays a paid coupon and an SNS social commerce service on standby for payment. The terminal 100 saves a coupon related to a service in a memory 160 separately and may be able to display coupons via a separate coupon box to represent the coupons to a user.

The saved coupon may be provided as an authenticating means for being actually provided with a service using barcodes or QR codes.

Referring to FIG. 10 (b), the terminal 100 displays the coupons of the SNS social commerce service in the coupon box 1030. According to the present invention, the terminal 100 may be also able to check whether coupons of other SNS subscribers joining the SNS social commerce service are used. For instance, in the drawing, if 7 members join an SNS social commerce service and settle payments, respectively, it may be able to determine which on of the 7 members has used the corresponding SNS social commerce service coupon.

In the following description, another example of application using the paid SNS social commerce service is explained.

FIG. 11 is a diagram for an operation of opening a coupon list of a paid SNS social service.

According to the present invention, after a specific SNS social commerce service has been paid, if a coupon related to the paid specific SNS social commerce service is received, a coupon list possessed by a terminal may be opened to other SNS friends.

Referring to FIG. 11 (a), the terminal 100 displays a coupon list of its own. And, a user may be able to select a target to open. After the user has selected the target to open, if a purchase list open menu 1120 is selected, the terminal 100 may be able to open an SNS social commerce service coupon possessed by the terminal 100 via a social network service.

Referring to FIG. 11 (b), a specific terminal 200 may be able to check a service coupon opened by the terminal 100 of another SNS subscriber through the social network service. In connection with opening the service coupon, the specific terminal 200 may be able to check the SNS subscriber 1130 having opened the service coupon, contact information 1140 and a coupon list 1150.

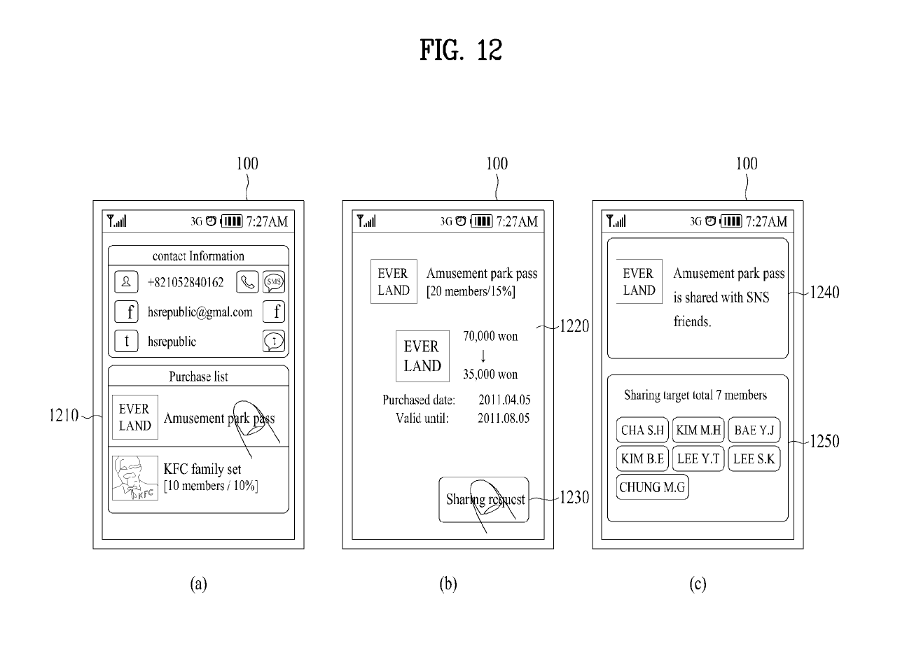

FIG. 12 is a diagram for an action to share a coupon of an SNS social commerce service according to the present invention.

According to the present invention, an SNS social commerce service coupon purchased by a specific person with other SNS friends. Owing to the property of a social network service, a variety of communications with various SNS friends are possible. And, the present invention enables a purchased coupon to be shared with other SNS friends in aspect of applying a social network service.

Referring to FIG. 12 (a), a specific terminal 100 displays a social commerce service coupon of its own. In this case, the social commerce service coupon 1220 may contain information on contents of a social commerce service, a fee and the like. If a user selects a sharing request menu 1220, the specific terminal 100 may be able to share a coupon with SNS friends via a social network service. If a coupon is shared, it may mean that SNS friends are able to use a social commerce service using the same coupon.

Referring to FIG. 12 (b), if the sharing request menu 1220 is selected, the specific terminal 100 displays details of the shared coupon. In particular, an information 1230 indicating that the coupon is shared and a shared target 1240 are displayed. Hence, SNS friends belonging to the shared target may be accessible to the shared coupon and may be able to use the social commerce service in a manner of downloading the corresponding coupon.

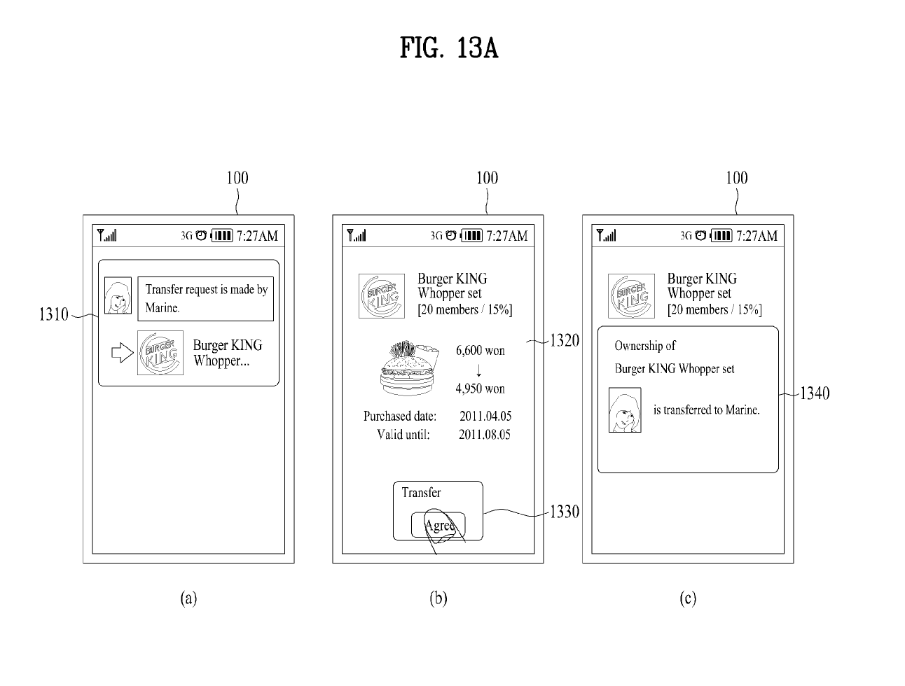

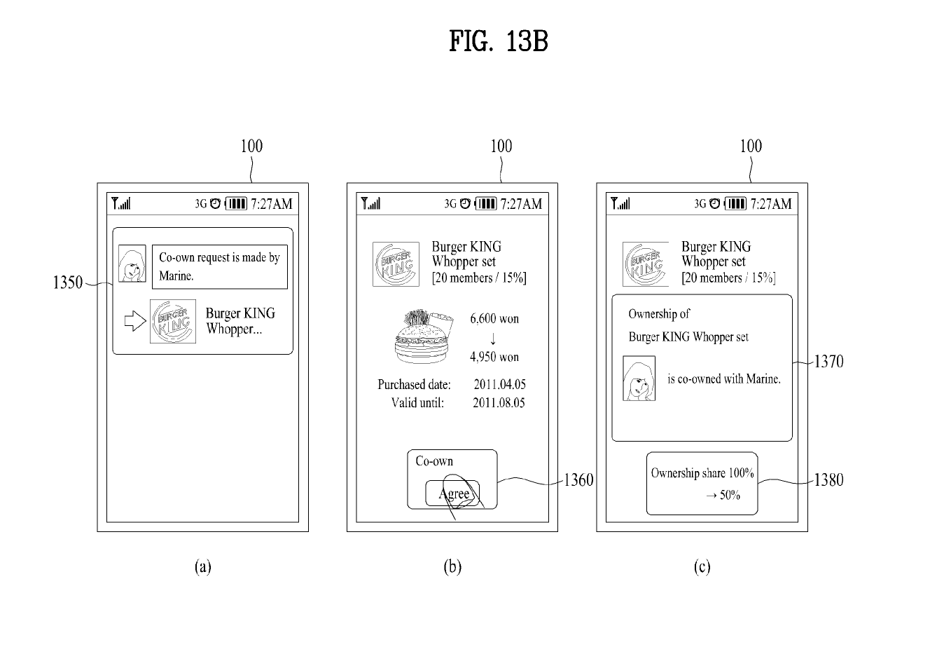

FIG. 13A and FIG. 13B are diagrams for an action of transferring a coupon of an SNS social commerce service entirely or in part according to the present invention.

Basically, a coupon for a social commerce service is only available for a terminal or user having paid for the corresponding service. And, the terminal or user having paid for the corresponding service has the ownership of the coupon. Yet, the present invention may provide a function of transferring the coupon entirely or in part in accordance with a selection made by a user possessing the coupon.

FIG. 13A shows a case that an ownership of a coupon is entirely transferred to a specific user.

Referring to FIG. 13A, if a request for transferring a coupon is made to a terminal 100 by a specific user [FIG. 13A (a)], the terminal 100 may be able to display an information 1320 on the coupon and a transfer consent menu 1330 [FIG. 13A (b)]. If a user selects the transfer consent menu, the ownership of the coupon may be entirely transferred to the specific user.

FIG. 13B shows a case that an ownership of a coupon is transferred in part to a specific user.

Referring to FIG. 13B, if a request for co-owning a coupon is made to a terminal 100 by a specific user [FIG. 13B (a)], the terminal 100 may be able to display an information on the coupon and a co-owning consent menu 1360 [FIG. 13B (b)]. If a user selects the co-owning consent menu 1360, the user and the specific user may be able to co-own the coupon. In connection with the co-owning process, the specific user may settle a corresponding expense. And, the SNS company 20 or a social network service party may provide a means for the expense settlement. Finally, if the coupon is co-owned, the terminal 100 may be able to display both a joint ownership information 1370 and an ownership share information 1380 together.

According to one embodiment of the present invention, the above-described social commerce service providing method can be implemented in a program recorded medium as computer-readable codes. The computer-readable media include all kinds of recording devices in which data readable by a computer system are stored. The computer-readable media include ROM, RAM, CD-ROM, magnetic tapes, floppy discs, optical data storage devices, and the like for example and also include carrier-wave type implementations (e.g., transmission via Internet).

The above-described mobile terminal may be achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention.

Accordingly, the present invention may provide the following effects and/or advantages.

First of all, a social commerce service providing method enables a subscriber terminal of SNS (social service network) to select a social commerce service initiatively.

Secondly, the social commerce service providing method facilitates the subscriber terminal to be provided with the social commerce service using a function on the SNS.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of providing a social commerce service, which is provided by a server managing SNS (social network service), comprising the steps of:
providing a sale information on a use authority of the social commerce service to a plurality of SNS subscriber terminals subscribed to the SNS, the sale information on the use authority including an information on a specific number of the SNS subscriber terminals intending to buy the use authority as a conclusion condition for selling the use authority of the social commerce service and an information on the social commerce service;
receiving an information on SNS subscribers amounting to the specific number or higher, the SNS subscribers intending to buy the use authority, the SNS subscribers invited by a specific SNS subscriber terminal among a plurality of the SNS subscriber terminals; and
if the SNS subscriber terminals amounting to the specific number or higher are confirmed to intend to buy the use authority of the social commerce service, selling the use authority of the social commerce service to each of the SNS subscriber terminals intending to buy the use authority.

2. The method of claim 1, the use authority selling step comprising the steps of:
providing payment-necessary information to each of the SNS subscriber terminals intending to buy the use authority;
receiving payment authentication information from each of the SNS subscriber terminals to correspond to the payment-necessary information; and
providing coupon information including the use authority of the social commerce service to each of the SNS subscriber terminals.

3. The method of claim 1, the use authority selling step comprising the steps of:
providing payment-necessary information required for collective payment for all of the SNS subscriber terminals intending to buy the use authority to the specific SNS subscriber terminal; and
receiving payment authentication information from the specific SNS subscriber terminal to correspond to the payment-necessary information.

4. The method of claim 3, the use authority selling step comprising one of the steps of:
providing coupon information including the use authority of the social commerce service to each of the SNS subscriber terminals intending to buy the use authority; and
providing the coupon information including the use authority of the social commerce service to the specific SNS subscriber terminal.

5. The method of claim 1, wherein in the step of receiving the information on the SNS subscribers intending to buy the use authority, the specific SNS subscriber terminal determines a specific social commerce service to buy the authority thereof, selects SNS friends from a plurality of the SNS subscribers linked to the specific SNS subscriber on an SNS network, sends a message for inviting to join in buying the specific social commerce service to terminals of the selected specific SNS friends, receives a buy-intended message from each of the terminals of the SNS subscribers intending to buy the use authority in response to the message, and determines whether the specific number is met as the conclusion condition for the social commerce service from the buy-intended message of each of the SNS subscribers.

6. The method of claim 1, wherein the sale information further comprises at least one selected from the group consisting of an expiry period for using the social commerce service, a volume information of the use authority of the social commerce service, a user response information on the social commerce service, and a user information on a user having selected the social commerce service.

7. A mobile terminal, which is provided with a social commerce service using SNS (social network service), comprising:
a wireless communication unit receiving a sale information on a use authority of each of at least one social commerce service from a server configured to manage the SNS, the sale information on the use authority including an information on a specific number of SNS subscriber terminals intending to buy the use authority as a conclusion condition for selling the use authority of the social commerce service and an information on the social commerce service;
a user input unit receiving an input of a selection action on a specific one of the at least one social commerce service and an input of a selection action on specific SNS subscribers to invite to buy the specific social commerce service; and
a controller controlling the wireless communication unit and the user input unit, the controller sending an invitation message for joining in buying the specific social commerce service to terminals of the selected specific SNS subscribers, the controller receiving a buy-intended message from SNS subscribers intending to buy the use authority in response to the invitation message, the controller determines whether the specific number is met as the conclusion condition of the specific social commerce service, the controller controlling information on SNS subscribers intending to buy the use authority to be transmitted to the SNS managing server.

8. The mobile terminal of claim 7, further comprising a display unit configured to provide an advertisement interface advertising for each of the at least one social commerce service using the sale information on the at least one social commerce service.

9. The mobile terminal of claim 8, wherein the display unit displays the number of terminals of SNS subscribers intending to buy the use authority.

10. The mobile terminal of claim 7, wherein the sale information comprises at least one selected from the group consisting of an expiry period for using the social commerce service, a volume information of the use authority of the social commerce service, a user response information on the social commerce service, and a user information on a user having selected the social commerce service.

11. The mobile terminal of claim 7, wherein if the conclusion condition for selling the use authority of the specific social commerce service is met as the SNS subscriber terminals over the specific number intend to buy the use authority, the wireless communication unit receives a coupon information including the use authority of the specific social commerce service from the SNS managing server.

12. The mobile terminal of claim 11, further comprising a memory configured to store the coupon information.
